(19) United States
(12) Patent Application Publication
(10) Pub. No.: US 2005/0202143 A1
(43) Pub. Date: Sep. 15, 2005

(54) Dry mix compositions and method for making and utilizing the same having an enhanced anti-microbial shelf life

(76) Inventors: Soumya Roy, Plymouth, MN (US); Lauren Shimek, Plymouth, MN (US); Jean L. Weber, Plymouth, MN (US); Ondine Baird, Edina, MN (US)

Correspondence Address: GENERAL MILLS, INC., P.O. BOX 1113, MINNEAPOLIS, MN, 55440, US

(21) Appl. No.: 10/799,397

(22) Filed: Mar. 12, 2004

(51) Int. Cl. A21D 10/00

(52) U.S. Cl. 426/549

(57) ABSTRACT

A food composition comprising a dry mix for production of a bakery product having an extended yeast-free and mold-free shelf life of at least 21 days. The dry mix comprising about 0.01% to about 1.0% of an encapsulated acid such as citric, fumaric, lactic, malic, phosphoric, sodium acid sulfate and mixtures thereof. A method of preparing bakery products having a shelf life enhancing composition are also described.

### CROSS REFERENCES TO RELATED APPLICATIONS

None

### FIELD OF THE INVENTION

The present invention relates to food products and to their methods of preparation. More particularly, the present invention relates to dry mix compositions containing an encapsulated acid for use in batter compositions, and finished bakery products having an enhanced shelf life and their methods of preparation.

### BACKGROUND OF THE INVENTION

The present invention relates to dry mix compositions containing flour, a leavening system, and an encapsulated acid; batter compositions prepared from said dry mix compositions, finished bakery products consisting of said batter compositions; and methods of providing such finished bakery products having an extended yeast-free and/or mold-free shelf life of at least 21 days, preferably an extended yeast-free and/or mold-free shelf life of more than 30 days, and most preferably an extended yeast-free and/or mold-free shelf life of at least 40 days. More specifically, in an exemplary embodiment the present invention relates to extended yeast-free and/or mold-free shelf life cake donuts and their methods of preparation.

Additionally, the present invention relates to dry mix compositions containing encapsulated acid, wherein the encapsulated acid is selected from the group consisting of citric acid, fumaric acid, lactic acid, malic acid, phosphoric acid, sodium acid sulfate and mixtures thereof.

Furthermore, the present invention relates to batter compositions for providing a fried bakery product comprising water, flour, a leavening system, and encapsulated acid having an extended yeast-free and/or mold-free shelf life of at least 21 days, preferably an extended yeast-free and/or mold-free shelf life of more than 30 days, and most preferably an extended yeast-free and/or mold-free shelf life of at least 40 days. More specifically, the present invention relates to batter compositions containing encapsulated acid, wherein the encapsulated acid is selected from the group consisting of citric acid, fumaric acid, lactic acid, malic acid, phosphoric acid, sodium acid sulfate and mixtures thereof.

In another embodiment, the present invention relates to baked bakery products prepared from batter compositions containing encapsulated acid, wherein the encapsulated acid is selected from the group consisting of citric acid, fumaric acid, lactic acid, malic acid, phosphoric acid, sodium acid sulfate and mixtures thereof.

Consumers throughout the world have increasingly developed an affinity for bakery products. Many bakery products, including cake donuts, snack cakes, brownies, cakes, muffins, waffles, crepes, churros, fritters, etc. are popular food items that can be consumed at virtually any time of the day. Convenience stores, grocery stores, and restaurants that sell bakery products typically have limited preparation and manufacturing spaces to prepare food products. In the case of bakery products, such as fried cake donuts and others, the considerable equipment and trained personnel required for production of these products virtually prohibits their production in a convenience store or a quick-service restaurant environment. With respect to donuts, the cooking processes involve measuring ingredients, mixing the batter, allowing the leavening to react in the batter, depositing individual-serving size portions of the batter into heated oil, deep-frying the donut batter in extremely hot oil and topping and/or filling the fried cooked donut. Especially with respect to the use of large quantities of extremely hot oil, these operations require extensive equipment and a number of specially trained personnel, both of which are commonly absent in the typical convenience store, grocery store, or restaurant.

One solution to space and personnel limitations has been the preparation of donuts and other such bakery products off-premises and then shipment of these products to the convenience store for display and sale.

Another solution to space and personnel limitations has been the preparation of dry mixes off-premises and then shipment of these dry mixes to convenience stores, bakeries and the like for production of such bakery products, wherein addition of moisture and optional ingredients is all that is required prior to frying or baking.

Typically, off-premise prepared donuts and other such bakery products have a limited shelf life of one day, although addition of preservatives can extend shelf life to up to six to seven days. Typically, baked bakery products and fried bakery products whether prepared on or off-premise must remain soft, edible, and mold free for six to seven days, preferably up to 21 days. Traditionally, food grade organic acids such as sorbic, propionic, and benzoic acids have been used as preservatives in baked bakery products and fried bakery products to inhibit yeast and/or mold growth and extend shelf life of the product. However, such food grade organic acids are not as effective at higher pH levels (>6). Fried bakery products, such as cake donuts and many baked bakery products typically have a neutral pH or slightly acidic or slightly basic pH of 6 to 8. At this pH range, the preservatives or food grade organic acids remain primarily in the dissociated form, which has less anti-microbial activity than the protonated acid form. By lowering the pH of the product, these preservatives can partition more towards the protonated acid form and therefore be more effective against microbial spoilage. However, the addition of an acid to a dry mix, batter, or dough may interfere with the leavening. Additionally, the shift of pH to slightly acid seems to compromise the general tolerance to formula and process variations. Furthermore, excessively high acidic pH levels appear to create off flavors and darker crumb and crust colors in the finished bakery product.

Surprisingly, by adding an encapsulated acid contained within a lipid coating; such as citric acid, fumaric acid, lactic acid, malic acid, phosphoric acid, sodium acid sulfate and mixtures thereof to a dry mix composition for use in a batter composition, the acid can be control released during frying or baking to lower the pH of the final product and provide a finished bakery product with an extended shelf-life. The acid does not release from the encapsulation until the batter obtains a specific temperature during frying or baking, thereby maintaining an appropriate pH level and thus preventing premature interaction with the leavening agents. The encapsulated acid, such as citric acid, fumaric acid, lactic acid, malic acid, phosphoric acid, or sodium acid sulfate and mixtures thereof may have additional anti-microbial properties, which can also extend the shelf life of the product.

In an embodiment, the present invention provides a batter comprising a dry mix containing an encapsulated acid, wherein the acid remains un-dissolved in the batter prior to frying or baking to provide a batter pH in the range of 6.0 to about 8.0. The encapsulated acid then dissolves in the batter during frying or baking, to adjust the pH range of the bakery products to 6.0 to 7.0.

The present invention resides in the discovery that the addition of encapsulated acid in a dry mix for preparing batter compositions for production of bakery products: 1) lowers the pH of the product during frying or baking without reacting with leavening; 2) increases the anti-microbial effectiveness of preservatives, such as benzoic acid, propionic acid, and sorbic acid, thereby extending finished product shelf-life; and 3) can impart anti-microbial benefits as well, thereby extending shelf-life of the finished product.

It is known to add encapsulated fumaric acid to dough having a pH of 5.5 to 6.0, to preserve anti-microbial ingredients after baking without deleteriously affecting the bread dough prior to baking. U.S. Pat. No. 6,312,741 discloses a mono-dispersed fumaric acid particulate having a mean particle size of from about 70 microns to about 140 microns encapsulated with a coating having a melting point within normal baking temperatures that can be added to dough to preserve the product after baking without deleteriously affecting the bread dough prior to baking. The coating used to coat the mono-dispersed fumaric acid particulate of U.S. Pat. No. 6,312,741 melts at a temperature greater than 125° F. (51° C.).

Batters and doughs as used herein are distinguishable compositions even though each comprises some number of common ingredients.

“Dough” as used herein refers to an intermediate food product that has a gluten-based structure. In dough, the gluten forms a continuous dough elastic medium into which other ingredients are embedded. A dough is typically prepared by beating, blending, cutting or kneading and is often stiff enough to cut into various shapes. Doughs generally are used for low sugar to flour ratio products such as breads, biscuits, etc. and generally have a pre-bake moisture content of less than 20% moisture.

In contrast, “Batter” as used herein refers to an intermediate food product that essentially contains flour, water, and salt and optionally such other ingredients as fat, eggs, and sugar(s) that are a starch-based composition. In a batter, gluten development is purposefully minimized. Batters are inextensible. Liquid added to make the batter forms a continuous batter medium in which other ingredients are dispersed. A batter cooks into a soft, moist and sometimes crumbly product. A batter is typically prepared by blending, creaming, stirring or whipping and is often thin enough to pour or scoop or squeeze out of a container. Within the meaning a “batter” herein is also meant those lower moisture thickened mixtures such as pastes.

“Baking” as used herein refers to the cooking of food via dry heat especially an oven although other heating mechanisms such as infrared and microwave heating can be used in full or partial substitution for baking preparation herein.

“Frying” as used herein refers to the cooking of food submersed in hot fat or oil, wherein oil is the heat transfer medium.

“Yeast-free and/or mold-free” as used herein refers to the absence of topical or visually apparent yeast and/or mold spots greater than a diameter of 0.01 mm on a finished product.

“Enhanced shelf life” and “Extended shelf life” as used herein are interchangeable and refers to a “yeast-free and/or mold-free” product as characterized above, absent of topicial or visually apparent yeast and/or mold spots greater than a diameter of 0.01 mm on a finished bakery product.

### BRIEF SUMMARY OF THE INVENTION

The present invention provides methods and products for preparing a bakery products having an enhanced shelf life of at least 21 days, preferably an enhanced shelf life of at least 30 days, more preferably an enhanced shelf life of at least 40 days prepared from a dry mix composition comprising flour, a leavening system and an encapsulated acid.

In an exemplary embodiment, the present invention provides methods and products for preparing a fried bakery product having an enhanced shelf life of at least 21 days, preferably an enhanced shelf life of at least 30 days, and more preferably an enhanced shelf life of at least 40 days comprising flour, sugar, water, a leavening system and an encapsulated acid.

In another exemplary embodiment, the present invention provides methods and products for preparing a baked bakery product having an enhanced shelf life of at least 21 days, preferably an enhanced shelf life of at least 30 days, and more preferably an enhanced shelf life of at least 40 days comprising flour, sugar, water, a leavening system and an encapsulated acid.

In its product aspect of one and the same invention, the present invention resides in dry mix compositions and batter compositions that provide improved fried and baked bakery products having an enhanced shelf life.

The dry mix composition comprises flour, a leavening system, and an encapsulated acid.

The batter composition comprises flour, a leavening system, encapsulated acid, sugar, water, and the balance of conventional batter ingredients such as starches, flavors, egg or egg solids, fat, gums, salt, etc.

In its process aspect, the present invention is directed to processes for making a fried bakery product having an enhanced shelf life of at least 21 days prepared from dry mix compositions. In an exemplary embodiment, the process comprises the steps of:
A. providing a dry mix, said mix on a dry weight basis comprising:
   about 50% to about 80% flour;
   a leavening system; and
   about 0.01% to about 1.0% encapsulated acid;
B. forming a batter comprising:
   said dry mix; and
   a moisture, in a ratio of dry mix to moisture of about 50:1 to about 1: 1;
C. allowing the leavening system to react in the batter;
D. depositing individual-serving size portions of the batter into heated oil;
E. deep-frying the batter in oil having a temperature of about 250° F. to about 400° F. (121° C.-204° C.) to produce a fried bakery products, wherein the fried bakery products achieve an internal cooked temperature of about 160° F. to about 220° F. (71° C.-104° C.).

In another exemplary embodiment, the present invention is directed to processes for making a baked bakery product having an enhanced shelf life of at least 21 days prepared from a dry mix composition, the process comprises the steps of:
A. providing a dry mix, said mix on a dry weight basis comprising:
   about 10% to about 60% flour;
   a leavening system; and
   about 0.01% to about 1.0% encapsulated acid;
B. forming a batter comprising:
   said dry mix; and
   a moisture, in a ratio of dry mix to moisture of about 35:1 to about 1.4:1;
C. allowing the leavening system to react in the batter;
D. depositing the batter into a baking container; and
E. baking the batter in an oven having a temperature of 300° F. to 450° F. (148° C.-232° C.) to produce a baked bakery products, wherein the baked bakery products achieve an internal cooked temperature of 160° F. to 220° F. (71° C.-104° C.).

These, as well as other objects and advantages of this invention, will be more completely understood and appreciated by referring to the following more detailed description of the presently preferred exemplary embodiments of the invention.

### DESCRIPTION OF THE PREFERRED EMBODIMENTS

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention relates to bakery products such as cake donuts, snack cakes, brownies, cakes, muffins, waffles, crepes, churros, fritters, etc. prepared from batter compositions prepared with a dry mix composition containing an encapsulated acid, and methods of providing such finished bakery products having an extended yeast-free and/or mold-free shelf life of at least 21 days, preferably an extended yeast-free and/or mold-free shelf life of more than 30 days, and most preferably an extended yeast-free and/or mold-free shelf life of at least 40 days. In an exemplary embodiment, the present invention relates to extended yeast-free and/or mold-free shelf life cake donuts comprising flour, sugar, water, a leavening system and an encapsulated acid and their methods of preparation.

Furthermore, the present invention relates to dry mix compositions comprising flour, a leavening system and encapsulated acid for providing a finished fried or baked bakery product having an extended yeast-free and/or mold-free shelf life of at least 21 days, preferably an extended yeast-free and/or mold-free shelf life of more than 30 days, and most preferably an extended yeast-free and/or mold-free shelf life of at least 40 days.

Additionally, the present invention relates to batter compositions comprising flour, sugar, water, a leavening system and encapsulated acid for providing a finished fried or baked bakery product having an extended yeast-free and/or mold-free shelf life of at least 21 days, preferably an extended yeast-free and/or mold-free shelf life of more than 30 days, and most preferably an extended yeast-free and/or mold-free shelf life of at least 40 days.

In its process aspect, an exemplary embodiment of the present invention is directed to processes for making a fried bakery product having an enhanced yeast-free and/or mold-free shelf life of at least 21 days, preferably an extended yeast-free and/or mold-free shelf life of more than 30 days, and most preferably an extended yeast-free and/or mold-free shelf life of at least 40 days. The process comprising the steps of:
A. providing a dry mix, said mix on a dry weight basis comprising:
   about 50% to about 80% flour;
   a leavening system; and
   about 0.01% to about 1.0% encapsulated acid;
B. forming a batter comprising:
   said dry mix; and
   a moisture, in a ratio of dry mix to moisture of about 50:1 to about 1:1;
C. allowing the leavening system to react in the batter;
D. depositing individual-serving size portions of the batter into heated oil;
E. deep-frying the batter in oil having a temperature of about 250° F. to about 400° F. (121° C.-204° C.) to produce a fried bakery products, wherein the fried bakery products achieve an internal cooked temperature of about 160° F. to about 220° F. (71° C.-104° C.).

In another exemplary embodiment of the present invention, the process comprises the steps of:
A. providing a dry mix, said mix on a dry weight basis comprising:
   about 10% to about 60% flour;
   a leavening system; and
   about 0.01% to about 1.0% encapsulated acid;
B. forming a batter comprising:
   said dry mix; and
   a moisture, in a ratio of dry mix to moisture of about 35:1 to about 1.4:1;
C. allowing the leavening system to react in the batter;
D. depositing the batter into a baking container; and
E. baking the batter in an oven having a temperature of 300° F. to 450° F. (148° C.-232° C.) to produce a baked bakery products, wherein the baked bakery products achieve an internal cooked temperature of 160° F. to 220° F. (71° C.-104° C.).

Each of these product components as well as methods of preparation, product use and attributes are described in detail below. Throughout the specification and claims, percentages are by dry weight and temperatures in degrees Fahrenheit unless otherwise indicated.

In an exemplary embodiment of the present invention, a dry mix composition comprising flour, a leavening system, an encapsulated acid and optionally the balance of conventional bakery product ingredients such as sugar, starches, flavors, egg or egg solids, fat, gums, salt, milk, and milk derivatives such as whey and caseinates, etc. is produced.

In another exemplary embodiment of the present invention, a batter composition comprising sugar, water, flour, a leavening system, an encapsulated acid and the balance of conventional batter ingredients such as starches, flavors, egg or egg solids, fat, gums, salt, milk, and milk derivatives such as whey and caseinates, etc. is produced.

The present dry mix compositions essentially contain from about 50% to about 80% flour on a dry weight basis. Conventionally, flour is standardized to about 14% moisture. Flour(s) useful herein can be of conventional type and quality including cake flour, bread flour and all-purpose flour. Both chlorinated or unchlorinated flours can be used depending on the application, as well as bleached and/or unbleached flours. Wheat flours are preferred but other flours conventionally used in the preparation of bakery products can also be employed in full or partial substitution for the wheat flour, including for example barley flour, corn flour, rice flour, soy flour and mixtures thereof.

The dry mix compositions of the present invention additionally comprise from about 20% to about 40% on a dry weight basis of a sugar or other nutritive carbohydrate sweetener ingredient. Typically, sucrose is used in mixes and batters for bakery products as the sugar ingredient. Useful sugars can include monosaccharides, disaccharides and their various degradation products. Examples of such sugars include the pentoses, xylose, arabinose, glucose, galactose, mannose, fructose, lactose, maltose, dextrose, sucrose, maltodextrins, high fructose corn syrup (HFCS), molasses and brown sugar. However, the use of reducing sugars such as dextrose, fructose, maltose, lactose, etc. is generally limited because of their ability to cause brown coloration of the batter via non-enzymatic browning. Commercially available milled sugar can be used and some applications can require sugar of a particular grind.

In certain variations, all or a part of the sweetener can be sugar alcohols such as maltitol, lactitol, isomalt, xylitol, erythritol, sorbitol, mannitol and/or other sugar alternatives such as inulin, trehalose, tagatose and mixtures thereof.

In certain variations, all or a part of the sweetener can be substituted by high potency sweeteners including aspartame, neotame, potassium acetysulfame, saccharin, sucralose, and dihydrochalones such as neohesperidine, thaumatin, glycyrrhizin, stevioside, maltol, and ethyl maltol. Preferred for use herein are those high potency sweeteners that are stable upon extended storage in acidic high moisture conditions and are also heat stable including sucralose and potassium acetysulfame and mixtures thereof. Bulking agents such as cellulose, and polydextrose and mixtures thereof can be used with high potency sweeteners to maintain the density of a finished product.

In another embodiment of the present invention, incidental quantities of sugar or high potency sweeteners can be added to the dry mix composition.

The present dry mix compositions can also comprise from about 2% to about 30% on a dry weight basis of an edible fat or shortening ingredient, in a preferred embodiment about 2% to about 12% edible fat or shortening. A shortening component adds richness to the eating properties of the finished bakery products. The particular fat constituent level will depend particularly upon the desired type of finished bakery product and its properties. In for example a fried bakery product that is to be stored for any length of time after frying, shortening is an essential ingredient. For example, cake donuts containing fat in the formula stay soft and more palatable for a longer period of time than donuts prepared without shortening. In addition to its anti-staling properties, shortening has other functions in fried bakery products. It gives fried bakery products an increased volume in comparison to fried bakery products containing no shortening. The increase in volume is significant, usually about 10%. Fat or shortening also acts as a plasticizer in the batter and can impact the amount of fat absorbed during frying. It will be appreciated that these added fat component levels are in addition to any fat level contribution such as the minor amount of added fat contributed by the coating component of the encapsulated acid ingredient.

Maintenance of shortening concentrations within the limits of about 2% to about 30% is important for providing bakery products of acceptable textural quality. Conventional shortening materials are suitable for use as the shortening ingredient of the present dry mix compositions and batter compositions. Such conventional shortening materials are well known in the art. The conventional shortenings useful herein are fatty glyceridic materials that can be classified on the basis of their physical state at room temperature. Liquid shortenings or oils can be used and provide the advantage of ease of incorporation. Solid shortening can also be used and provides the advantage of desirable mouth feel upon consumption. More commonly, and preferred for use herein, are mixtures of liquid and solid shortenings. Such mixes can be fluid or plastic depending in part upon the level of solid fatty materials.

The solid fatty glycerides can include fatty mono-glycerides and diglycerides of saturated fatty acids having 16 to 22 carbon atoms. The liquid shortening can be animal, vegetable or synthetic oil (e.g., sucrose polyesters) that is liquid at ordinary room temperatures. Representatives of such liquid shortenings are coconut oil, palm kernel oil, cottonseed oil, peanut oil, olive oil, sunflower seed oil, sesame seed oil, corn oil, safflower oil, poppy seed oil, soybean oil, canola (rapeseed) oil, babassu oil and the like.

The present dry mix compositions can further comprise about 0.01% to about 1.0% of an encapsulated food grade acid, preferably about 0.05% to about 0.4%. The encapsulated acid can be selected from the group consisting of citric acid, fumaric acid, lactic acid, malic acid, phosphoric, or sodium acid sulphate and mixtures thereof. The skilled artisan will have little difficulty selecting commercially available encapsulated food grade acids for use herein. In an exemplary embodiment of the present invention, encapsulated fumaric acid under the trade name Durkote Fumaric Acid 150-86a from Loders Croklaan in Wormeveer, Netherlands can be used.

In an exemplary embodiment of the present invention the encapsulated acid is a coated particulate having a mean particle size of from about 150 microns to about 840 microns. Less than 8% of the coated particulates have a particle size less than 150 microns, and less than 4% of the coated particulates have a particle size greater than 840 microns. The large particulate size surprisingly is beneficial in producing the appropriate release rate of the particulate in the present invention. The coated encapsulated acid particulate has a melting point of 150° F. (65° C.) or above. The coating is an edible material selected from the group consisting of lipid materials such as, but not limited to mono-, di- and triglycerides, waxes, and organic esters derived from animals, vegetables, minerals, and modifications. Some examples include soybean oil, cottonseed oil, canola oil, camuba wax, beeswax, bran wax, tallow, palm kernel oil and mixtures thereof. The encapsulated acid is from about 10% to about 30% by weight coating, and accordingly, is from about 70% to about 90% by weight encapsulated acid particulate.

The encapsulated acid should be present in the batter from about 0.01% to 1.0% on a dry weight basis, and is preferably present in an amount from about 0.2% to about 0.4%, and is most preferably present in the composition at about 0.3% dry weight basis.

The encapsulated acid particulate is encapsulated using conventional methods known in the industry, such as fluid bed and spray drying.

The present dry mix compositions can further comprise about 0.01% to about 4% of emulsifier(s), preferably about 0.05% to about 4%, and most preferably about 0.05% to about 1%. In an exemplary embodiment, the present invention comprises about 0.05% to about 0.4% on a dry weight basis of emulsifier(s). The shortening provides a convenient carrier for addition of emulsifiers to the dry mix composition. Such emulsifiers aid the realization of fried bakery products with improved grain structure and texture. The emulsifier is also useful to maintain the emulsion integrity of the batter compositions over extended room temperature storage.

All or a portion of the emulsifier(s) component can be admixed with the shortening component. The emulsifier typically comprises from about 1% to about 20% of the shortening component, preferably from about 5% to about 15% and, most preferably from about 10% to about 15%.

Alternatively, emulsifiers may be prehydrated in an aqueous dispersion and added to the batter compositions. They can also be part of an emulsion or dispersion with or without fat component in the dry mix composition or alternatively in the batter composition. Generally useful as the emulsifiers are partially esterified polyhydric compounds having surface-active properties. This class of emulsifiers includes among others, mono- and diglycerides of fatty acids and/or the acetylated forms of mono- and diglycerides, such as monopalmitin, monostearin, monoolein, dipalmitin, and acetylated monoglycerides; partial fatty esters of glycols, such as propylene glycol monostearate; higher fatty acid esters of sugars, such as the partial palmitic and oleic acid esters of sucrose; phosphoric and sulfuric acid esters, such as dodecyl-glyceryl ether sulfate and monostearin phosphate; and phospholipids, such as lecithin. Other examples include the partial esters of hydroxycarboxylic acids, such as lactic, citric, and tartaric acids with polyhydric compounds, for example, glycerol lacto-palmitate, and the polyoxyethylene esters of fatty esters of polyhydric alcohols, such as a polyoxyethylene esters of sorbitan monostearate or distearate. Fatty acids alone or esterified with a hydroxy carboxylic acid, e.g., stearyl-2-lactylate, are also useful.

In an exemplary embodiment of the present invention a chemical leavening system is employed. Chemical leavening systems typically include a food grade acid and a base, which react to form carbon dioxide which is then trapped in the cell walls of the batter to leaven the mass upon frying or baking. The acid and base components of the chemical leavening system of the present invention can be sequestered to prevent them from reacting with one another until the desired time. For example, the leavening system can include a heat activated leavening acid such as sodium acid pyrophosphate, which does not interact with the leavening base (e.g., as sodium bicarbonate) until a particular temperature is reached. Alternatively, the leavening agent can include encapsulated sodium bicarbonate, which is physically prevented from reacting with the leavening acid until certain conditions are reached. The baking soda is then released from the encapsulate and leavening takes place.

Baking soda is a leavening base that is the primary source of carbon dioxide gas in many chemical leavening systems. This compound is stable and relatively inexpensive to produce. Baking soda can be used in either an encapsulated form or in a non-encapsulated form. Use of an encapsulated baking soda delays the onset of the leavening reaction as the encapsulating material must first be dissolved before the leavening reaction can occur.

Leavening acids include sodium or calcium salts of ortho, pyro, and complex phosphoric acids in which at least two active hydrogen ions are attached to the molecule. Baking acids include monocalcium phosphate monohydrate (MCP), monocalcium phosphate anhydrous (AMCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-delta-lactone (GDL), potassium hydrogen tartrate (cream of tartar) and the like. The preferred leavening system includes sodium acid pyrophosphate and baking soda. Typically, the leavening system makes up about 0.5% to about 5% of the dry weight basis of the dry mix composition, preferably about 1% to about 2.5% of the dry weight basis of the dry mix composition. The ratio of leavening acid to leavening base is about 1:1 to 1.5:1.

Alternatively, the leavening system can be a yeast-leavened system, wherein the yeast becomes non-viable upon baking or frying of the batter.

If desired the present invention can further comprise about 0.5% to about 8% of a humectant on a dry weight basis, preferably about 1% to about 6%. Humectant addition is useful in achieving an acceptable water activity level. The humectant can be any commonly employed humectants ingredient. Preferred humectants are selected from the group consisting of sorbitol, xylitol, mannitol, glycerin, glycerol, propylene glycol and mixtures thereof. Preferred for use herein is a mixture of sorbitol and glycerin or glycerin by itself.

The present invention can further comprise an anti-mycotic agent to enhance microbial stability. Useful agents include sorbic acid and its derivatives such as sodium or potassium sorbate, propionic acid and its derivatives, vinegar, sodium diacetate, monocalcium phosphate, lactic acid, citric acid and so on. These agents are present in an amount to aid in the inhibition of growth of undesirable yeast and/or molds, typically about 0.01 to 1.0% of dry weight basis ingredient such as sodium propionate, potassium sorbate, calcium propionate, sorbic acid and mixtures thereof. The anti-mycotic ingredient can be present in a range of about 0.01% to about 1.0% on a dry weight basis of the dry mix composition.

Certain embodiments of the present invention can additionally comprise about 0.05% to about 0.7% of a hydrophilic colloid, preferably about 0.05% to about 0.5% of a hydrophilic colloid.

In preferred embodiments, the hydrophilic colloid is selected from the group consisting of carboxymethyl cellulose, dextrin, gellan, guar, karaya, locust bean, xanthan, or others and mixtures thereof.

The present invention can further comprise a starch ingredient. Starch addition can be used to influence a variety of product attributes including viscosity, finished products volume and texture. The starch used can be any of the common food starches, for example, potato starch, corn starch, wheat starch, rice starch, barley starch, oat starch, tapioca starch, arrowroot, and sago starch. Modified starches and pregelantinized starches can also be used. If present the added starch ingredient(s) can comprise about 0.1% to about 10%, preferably about 0.5% to about 5% of the dry mix compositions, most preferably about 0.5% to about 1.5% of the dry mix composition on a dry weight basis.

Still another useful optional ingredient in the present invention is a nonfat dry milk solid. Nonfat dry milk solids aid the structuring of the finished bakery products. If present, such dry milk solids can comprise from about 0.5% to about 4.0% on a dry weight basis of the present dry mix compositions, preferably about 1.5% to about 3%. In other variations, various milk fractions such as whey or whey proteins can be added along with the nonfat dry milk solids.

The present dry mix compositions can optionally contain a variety of additional minor ingredients or “conventional additives” suitable for rendering finished bakery products prepared therefrom more organoleptically desirable. Such optional dry mix components include anti-oxidants, vitamins, minerals, flavor/coloring agents, salt, flavor chips, nuts, fruit pieces or other edible inclusions. Flavor chips include chocolate, mint chocolate, butterscotch, peanut butter chips and mixtures thereof. The flavor chips can be coated with topical film to minimize moisture migration such as with a hard fat or with edible shellac. If present such additional minor ingredients can be present in the dry mix compositions at levels ranging from about 5% to about 15% on a dry weight basis.

In an embodiment of the present invention major and/or minor ingredients or “conventional additives” can be added directly to the batter composition during mixing of dry and wet ingredients. For example, some bakeries, convenience stores and the like prefer to obtain a dry mix composition containing no sugar. Thereafter, the bakery adds the sugar and wet ingredients to the dry mix composition in preparation to produce a finished bakery product.

The particular selection of ingredients and concentration are selected to provide finished bakery products having a water activity of less than 0.92 and for best results less than 0.85 to about 0.55.

Prior to baking or frying, the present invention is preferably not acidified and thus ranges in pH from about 6.0 to 8.0.

In a method of preparation, the dry mix compositions of the present invention are prepared by blending the ingredients together via a batch or continuous mix system to produce a well-blended dry mix. Thereafter, the dry mix can be packaged and supplied to customers in convenient conventional packaging containers such as five, ten, fifty pound bags, etc. or bottles, gable topped cartons, and the like in a variety of sizes and shapes.

Alternatively, a batter composition comprising the dry mix composition, moisture and optional ingredients can be prepared and supplied to customers in convenient conventional packaging containers such as bottles, gable topped cartons, and the like in a variety of sizes and shapes. The batter composition can be refrigerated during shipping and storage.

Additionally, the present batters for use in preparing fried bakery products have a dry mix to moisture ratio of about 50:1 to about 1:1, preferably a dry mix to moisture ratio of about 3:1 to about 2:1. The present batter compositions for use in preparing a baked bakery products have a dry mix to moisture ratio of about 35:1 to about 1.4:1. The moisture includes water provided with or associated with the various essential and optional ingredients. For example, total moisture includes the moisture associated with flour, starch, milk and especially liquid eggs. In some embodiments liquid egg yolks are used, as egg whites can restrict fat absorption during frying. In some embodiments, only dry egg solids are added, water is then added to the batter as part of an emulsion or dispersion containing other active ingredients such as emulsifiers, polyols, etc.

In a method of preparation, the dry mix ingredients can be blended. Thereafter, the liquid ingredients are combined to form a wet mixture. A portion of the water can be used to prehydrate the emulsifiers. The wet mixture and the dry mix composition are then combined to form a batter. The batter can, for example, be prepared in a batch or a continuous mixing device.

The dry and wet ingredients are uniformly dispersed upon mixing creating a hydrated structure. In some embodiments, the batter is provided a resting period to allow the batter to continue to hydrate and for leavening action to begin thus aerating the batter.

Thereafter, the batter can be shaped via a depositor into rings, circles, triangles, rectangles and various other shapes. The shaped batter is dropped into hot fat/oil having a temperature of at least 270° F. (132° C.) for a period of 10 to 60 seconds or until the interior of the shape reaches a temperature of about 170° F. to about 230° F. (76° C. -110° C.). The deep-frying process preserves the shape, provides the donut with a crust and forces moisture out of the donut, thereby allowing for absorption of fat.

A fried bakery product contains three distinct regions, a) a crust or fried region; b) a baked region; and c) a inner region or core. The crust or fried region is the crisp brown outer layer where most of the frying fat is absorbed. The baked region is a cake-like region that absorbs minimal fat. The inner region or core is the region that retains a higher level of moisture and provides a moist texture because the region isn't exposed to sufficient heat.

A pH of equal to or greater than 6.8 in the batter is desirable, upon frying the encapsulated acid is released to produce a product having a desirable pH of between 6.0 to 6.5. A lower pH in the batter affects fat absorption by decreasing the absorption. A desirable fat level aids in an optional sugar coating process allowing the coating to desirably adhere to the fried bakery product. Additionally, proper fat absorption aids in minimizing moisture migration. Finished bakery products having pH values within this range exhibit acceptable flavor absent an undesirable tartness of more acidic products.

In an exemplary embodiment of the present invention, the finished bakery fried product based on total weight contains about 15% to about 30% moisture and about 17% to about 35% fat, of which about 80% to about 85% of the fat is absorbed fry fat.

In an alternative embodiment, upon mixing, the batter composition can be placed in a suitable baking container and thereafter placed in an oven having a temperature of 300° F. to about 450° F. (148° C.-232° C.) until the bakery products achieve an internal cooked temperature of about 160° F. to about 220° F. (71° C.-104° C.).

The finished baked bakery product based on total weight contains about 10% to about 25% moisture and about 2% to about 20% fat in the finished product.

The addition of encapsulated acids can additionally have potential for use in dough and bread products. The addition of the encapsulated acids can increase the food product shelf life and reduce microbial spoilage.

The above specification, examples and data provide a description of the invention. Since many embodiments of the invention are possible without departing from the spirit and scope of the invention, the invention resides in the claims hereinafter appended.

1. A dry mix composition for use in a bakery product, comprising:
about 50% to about 80% flour;
a leavening system; and
about 0.01% to about 1.0% encapsulated acid; wherein the encapsulated acid having a mean particle size of about 150 microns to about 840 microns is selected from the group consisting of citric acid, fumaric acid, lactic acid, malic acid, phosphoric acid, sodium acid sulfate and mixtures thereof.

2. A bakery product produced by the dry mix composition of claim 1 having an extended yeast-free and or mold-free shelf life of at least 21 days.

3. A bakery product produced by the dry mix composition of claim 1 having an extended yeast-free and or mold-free shelf life of at least 30 days.

4. A bakery product produced by the dry mix composition of claim 1 having an extended yeast-free and or mold-free shelf life of at least 40 days.

5. A bakery product produced by the dry mix composition of claim 1 wherein the bakery product is a cake donut.

6. The dry mix composition of claim 1 additionally comprising a food grade organic acid selected from the group consisting of benzoic, propionic, sorbic and mixtures thereof.

7. The dry mix composition of claim 1 additionally comprising about 20% to about 40% sugar.

8. The dry mix composition of claim 1 additionally comprising about 2% to about 30% of a fat.

9. The dry mix composition of claim 1 additionally comprising about 0.01% to about 4% of an emulsifier.

10. The dry mix composition of claim 1 additionally comprising about 1% to about 8% of a humectant.

11. The dry mix composition of claim 1 additionally comprising about 0.05% to about 0.7% of a hydrophilic colloid.

12. The dry mix composition of claim 1 additionally comprising starch.

13. The dry mix composition of claim 1 additionally comprising nonfat dry milk solids.

14. The dry mix composition of claim 1 additionally comprising flavor agents.

15. The dry mix composition of claim 1 additionally comprising color agents.

16. The dry mix composition of claim 1 additionally comprising edible inclusions.

17. The dry mix composition of claim 1 wherein the dry mix is used to produce a fried bakery product.

18. The dry mix composition of claim 1 wherein the dry mix is used to produce a baked bakery product.

19. A batter composition for use in a bakery product, comprising:
about 10% to about 80% flour;
a leavening system;
about 0.01% to about 1.0% encapsulated acid; and
a moisture, in a ratio of about 50:1 to about 1:1;
wherein the encapsulated acid is selected from the group consisting of citric acid, fumaric acid, lactic acid, malic acid, phosphoric acid, sodium acid sulfate and mixtures thereof.

20. A bakery product produced by the batter composition of claim 19 having an extended yeast-free and or mold-free shelf life of at least 21 days.

21. A bakery product produced by the batter composition of claim 19 having an extended yeast-free and or mold-free shelf life of at least 30 days.

22. A bakery product produced by the batter composition of claim 19 having an extended yeast-free and or mold-free shelf life of at least 40 days.

23. The batter composition of claim 19 wherein the batter is fried to produce a fried bakery product.

24. The batter composition of claim 19 wherein the batter is baked to produce a baked bakery product.

25. The batter composition of claim 19 additionally comprising a food grade organic acid selected from the group consisting of benzoic, propionic, sorbic and mixtures thereof.

26. The batter composition of claim 19 additionally comprising about 2% to about 30% of a fat.

27. The batter composition of claim 19 additionally comprising about 0.01% to about 4% of an emulsifier.

28. The batter composition of claim 19 additionally comprising about 1% to about 8% of a humectant.

29. The batter composition of claim 19 additionally comprising about 0.05% to about 0.7% of a hydrophilic colloid.

30. The batter composition of claim 19 additionally comprising starch.

31. The batter composition of claim 19 additionally comprising nonfat dry milk solids.

32. The batter composition of claim 19 additionally comprising flavor agents.

33. The batter composition of claim 19 additionally comprising color agents.

34. The batter composition of claim 19 additionally comprising edible inclusions.

35. A method for preparing a bakery product, comprising the steps of:
A. providing a dry mix, said mix on a dry weight basis comprising:
about 50% to about 80% flour;
a leavening system; and
about 0.01% to 1.0% encapsulated acid;
B. forming a batter comprising;
said dry mix;
a moisture, in a ratio of dry mix to moisture of about 50:1 to about 1:1;
C. allowing the leavening system to react in said batter;
D. depositing individual-serving size portions of said batter into heated oil;
E. deep-frying the batter in oil having a temperature of about 250° F. to about 400° F. (121° C.-204° C.) to produce a fried bakery product, wherein the fried bakery product achieves an internal cooked temperature of about 160° F. to about 180° F. (71° C.-104° C.); and
wherein said fried bakery products have an yeast-free and mold-free shelf life of at least 21 days.

36. The method of claim 35 wherein the encapsulated acid of said dry mix is selected from the group consisting of citric acid, fumaric acid, lactic acid, malic acid, phosphoric acid, sodium acid sulfate and mixtures thereof.

37. The method of claim 35 wherein the encapsulated acid of said dry mix having a mean particle size of from about 150 microns to about 840 microns.

38. The method of claim 35 wherein the fried bakery products have a yeast-free and mold-free shelf life of at least 30 days.

39. The method of claim 35 wherein the fried bakery products have a yeast-free and mold-free shelf life of at least 40 days.

40. The method of claim 35 wherein the dry mix additionally comprises a food grade organic acid selected from the group consisting of benzoic, propionic, sorbic and mixtures thereof.

41. The method of claim 35 wherein the dry mix additionally comprises about 20% to about 40% of a sugar.

42. The method of claim 35 wherein the dry mix additionally comprises about 2% to about 12% of a fat.

43. The method of claim 35 wherein the dry mix additionally comprises about 0.01% to about 4% of an emulsifier.

44. The method of claim 35 wherein the dry mix additionally comprises nonfat dry milk solids.

45. The method of claim 35 wherein the leavening system is a chemical leavening system.

46. A method for preparing a bakery product, comprising the steps of:
A. providing a dry mix, said mix on a dry weight basis comprising:
about 10% to about 60% flour;
a leavening system; and
about 0.01% to 1.0% encapsulated acid;
B. forming a batter comprising:
said dry mix; and
a moisture, in a ratio of dry mix to moisture of about 35:1 to about 1.4:1;
C. allowing the leavening system to react in the batter;
D. depositing the batter into a baking container;
E. baking the batter in an oven having a temperature of about 300° F. to about 450° F. (148° C.-232° C.) to produce a baked bakery products, wherein the baked bakery products achieve an internal cooked temperature of 160° F. to about 220° F. (71° C.-104° C.).

47. The method of claim 46 wherein the encapsulated acid of said dry mix is selected from the group consisting of citric acid, fumaric acid, lactic acid, malic acid, phosphoric acid, sodium acid sulfate and mixtures thereof.

48. The method of claim 46 wherein the encapsulated acid of said dry mix having a mean particle size of from about 150 microns to about 840 microns.

49. The method of claim 46 wherein the baked bakery products have a yeast-free and mold-free shelf life of at least 30 days.

50. The method of claim 46 wherein the baked bakery products have a yeast-free and mold-free shelf life of at least 40 days.

51. The method of claim 46 wherein the batter additionally comprises a food grade organic acid selected from the group consisting of benzoic, propionic, sorbic and mixtures thereof.

52. The method of claim 46 wherein the dry mix additionally comprises about 20% to about 40% of a sugar.

53. The method of claim 46 wherein the dry mix additionally comprises about 2% to about 30% of a fat.

54. The method of claim 46 wherein the dry mix additionally comprises about 0.05% to about 4% of an emulsifier.

55. The method of claim 46 wherein the dry mix additionally comprises nonfat dry milk solids.

56. The method of claim 46 wherein the leavening system is a chemical leavening system.
